(19) United States
(12) Patent Application Publication
(10) Pub. No.: US 2012/0322502 A1
(43) Pub. Date: Dec. 20, 2012

(54) MULTIBAND MULTIMODE WIRELESS COMMUNICATION APPARATUS AND ELECTRONIC DEVICE HAVING THE SAME

(75) Inventors: Chang Won SONG, Suwon-si (KR); Yong Soo SONG, Seoul (KR); Cheol Woong PARK, Yongin-si (KR)

(73) Assignee: SAMSUNG ELECTRONICS CO. LTD., Suwon-si (KR)

(21) Appl. No.: 13/413,042

(22) Filed: Mar. 6, 2012

(30) Foreign Application Priority Data
Jun. 20, 2011 (KR) 10-2011-0059519

(51) Int. Cl. H04W 88/02

(52) U.S. Cl. 455/553.1

(57) ABSTRACT

A MultiBand-MultiMode (MBMM) wireless communication apparatus for performing seamless wireless communication by supporting Inter-Radio Access Technology (RAT) handover between communication networks according to different access types is provided. The apparatus includes a first Radio Frequency (RF) unit accessing a first wireless network, a second RF unit accessing a second wireless network having a different access type than the first wireless network, an interface unit connected to a target electronic device, and a switching unit connected to both the first and second RF units. The switching unit connects at least one of the RF units to the interface unit for communicating with the target electronic device. The first RF unit selects one of the RF units according to a camping order of the RF units or according to signal receiving conditions of the RF units, and controls the switching unit to connect the selected RF unit to the interface unit.

### PRIORITY

This application claims the benefit under 35 U.S.C. §119(a) of a Korean patent application filed on Jun. 20, 2011 in the Korean Intellectual Property Office and assigned Serial No. 10-2011-0059519, the entire disclosure of which is hereby incorporated by reference.

### BACKGROUND OF THE INVENTION

1. Field of the Invention

The present invention relates to a MultiBand-MultiMode (MBMM) wireless communication apparatus and an electronic device having the MBMM wireless communication apparatus. More particularly, the present invention relates to a MBMM wireless communication apparatus that performs a seamless wireless communication by supporting Inter-Radio Access Technology (RAT) handover between communication networks based on different access types, and an electronic device having the MBMM wireless communication apparatus.

2. Description of the Related Art

The MBMM wireless communication apparatus typically is a device that allows a selective access to a plurality of communication networks according to different access types in order to perform a wireless communication. For instance, the MBMM wireless communication apparatus has both a Wireless Interoperability for Microwave Access (WiMAX) modem based on a Third and a Half Generation (3.5G) mobile communication standard Institute for Electrical and Electronics Engineers (IEEE) 802.16e and a Long Term Evolution (LTE) modem based on Fourth Generation (4G) mobile communication standard, and selectively enables one of these modems to perform a wireless communication. In a case where there is a transfer or handover of a mobile terminal from a current communication network to any other neighboring communication network, this MBMM wireless communication apparatus requires effective Inter-RAT handover technology to realize a seamless wireless communication.

In a MBMM wireless communication apparatus of the related art, one modem acts as a master modem that generally controls Inter-RAT handover, and the other modem acts as a slave modem. Namely, while the master modem is connected directly to a target electronic device, the slave modem is connected indirectly to the target electronic device through the master modem. Therefore, the slave modem has a relatively slower data processing speed because data communication between the slave modem and the target electronic device is always performed through the master modem. Furthermore, a slow response speed of the slave modem in an Inter-RAT handover may cause a disconnection of data transmission/reception and thus, disrupt communication with the MBMM wireless communication apparatus.

### SUMMARY OF THE INVENTION

Aspects of the present invention are to address at least the above-mentioned problems and/or disadvantages and to provide at least the advantages described below. Accordingly, an aspect of the present invention is to provide a MultiBand-MultiMode (MBMM) wireless communication apparatus that allows all modems to perform a direct data communication with an electronic device, promptly responds to Inter-Radio Access Technology (RAT) handover, and improves efficiencies of an uplink and a downlink.

Another aspect of the present invention is to provide an electronic device having the above MBMM wireless communication apparatus.

In accordance with an aspect of the present invention, a wireless communication apparatus is provided. The apparatus includes a first Radio Frequency (RF) unit for accessing a first wireless communication network, and for performing a wireless communication with the first wireless communication network, a second RF unit for accessing a second wireless communication network, the second wireless communication network being of a different access type than the first wireless communication network, and for performing wireless communication with the second wireless communication network, an interface unit connected to a target electronic device, and a switching unit connected to each of the first and second RF units and for connecting at least one of the first and second RF units to the interface unit so that at least one of the first and second RF units communicates with the target electronic device, wherein the first RF unit selects one of the first and second RF units according to information regarding a camping order of the first and second RF units or according to signal receiving conditions of the first and second RF units, and wherein the first RF unit controls the switching unit so that the selected one of the first and second RF units is connected to the interface unit.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram illustrating the configuration of a MultiBand-MultiMode (MBMM) wireless communication apparatus according to an exemplary embodiment of the present invention.

FIG. 2 is a block diagram illustrating the configuration of a Long Term Evolution (LTE) Radio Frequency (RF) unit according to an exemplary embodiment of the present invention.

FIG. 3 is a block diagram illustrating the configuration of a MBMM wireless communication apparatus according to another exemplary embodiment of the present invention.

FIG. 4 is a block diagram illustrating the configuration of a MBMM wireless communication apparatus according to still another exemplary embodiment of the present invention.

FIG. 5 is a block diagram illustrating the configuration of a MBMM wireless communication apparatus according to yet another exemplary embodiment of the present invention.

FIG. 6 is a block diagram illustrating the configuration of an electronic device according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Furthermore, well known or widely used techniques, elements, structures, and processes may not be described or illustrated in detail to avoid obscuring the essence of the present invention. Although the drawings represent exemplary embodiments of the invention, the drawings are not necessarily to scale and certain features may be exaggerated or omitted in order to better illustrate and explain the present invention.

A MultiBand-MultiMode (MBMM) wireless communication apparatus, according to exemplary embodiments of the present invention, is connectable with any target electronic device, transmits or receives data to or from the target electronic device, and receives power from the target electronic device or by using a built-in power source. Additionally, a MBMM wireless communication apparatus may include two or more modems therein and selected from among wireless communication modems having different access types or technologies, such as a Global System for Mobile (GSM) communications modem, a Code Division Multiple Access (CDMA) modem, a Wideband Code Division Multiple Access (WCDMA) modem, a Wireless Interoperability for Microwave Access (WiMAX) modem, a Long Term Evolution (LTE) modem, a Time Division-Synchronous Code Division Multiple Access (TD-SCDMA) modem, a High Speed Packet Access (HSPA) modem, an Evolved High Speed Packet Access (HSPA+) modem, and a Wi-Fi modem. Furthermore, a MBMM wireless communication apparatus supports Inter-Radio Access Technology (RAT) handover by which an electronic device switches communication networks for uplink and downlink.

An electronic device according to the exemplary embodiments of the present invention is connected to a MBMM wireless communication apparatus, transmits and receives data to and from the MBMM apparatus, and may supply power to the MBMM apparatus. Additionally, the electronic device may include a MBMM wireless communication apparatus therein. Furthermore, an electronic device according to exemplary embodiments of the present invention may be one of communication devices, multimedia players and their associated equipment, such as a desktop Personal Computer (PC), a notebook PC, a tablet PC, a smart phone, a Personal Digital Assistant (PDA), or other similar electronic devices.

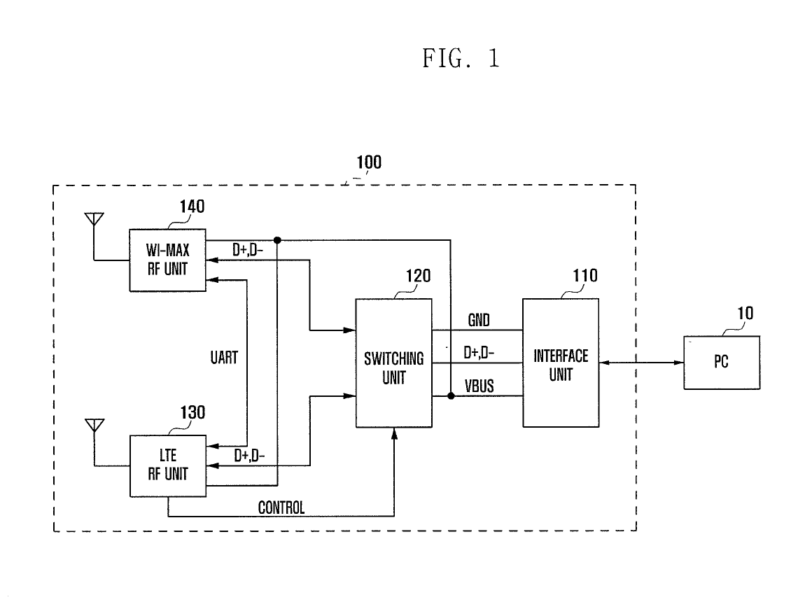

FIG. 1 is a block diagram illustrating the configuration of a MBMM wireless communication apparatus according to an exemplary embodiment of the present invention.

Referring to FIG. 1, a MBMM wireless communication apparatus 100 may include an interface unit 110, a switching unit 120, a LTE Radio Frequency (RF) unit 130, and a WiMAX RF unit 140.

The interface unit 110 connects the MBMM wireless communication apparatus 100 to any target electronic device 10 such as, but not limited to, a PC. Specifically, the interface unit 110 delivers power from the target electronic device 10 to the switching unit 120, the LTE RF unit 130 and the WiMAX RF unit 140, and also relays data and control signals between the switching unit 120 and the target electronic device 10. The interface unit 110 may include a Universal Serial Bus (USB) interface, for example.

The switching unit 120 connects one of the LTE RF unit 130 and the WiMAX RF unit 140 to the interface unit 110. Specifically, under the control of the LTE RF unit 130 or the target electronic device 10, the switching unit 120 relays data and control signals between the LTE RF unit 130 and the interface unit 110 or relays data and control signals between the WiMAX RF unit 140 and the interface unit 110. The switching unit 120 may be a USB hub or multiplexer, or any other suitable switching device, hub or multiplexer.

The LTE RF unit 130 accesses the LTE communication network, or in other words, camps on the LTE communication network, and then performs a location registration and a data communication. Also, the LTE RF unit 130 transmits and receives signals related to a voice call, a video call, a Short Message Service (SMS), a Multimedia Message Service (MMS), and a data communication to and from the target electronic device 10 through the switching unit 120 and the interface unit 110.

Although not shown in FIG. 1, the LTE RF unit 130 includes a front end, an amplifier, a transceiver, and an LTE modem. The front end performs band-pass filtering for downlink RF signals received from the antenna, that is, the front end lets the downlink RF signals in the LTE frequency band pass through, and performs a band-pass filtering for uplink RF signals to be sent to the antenna. The amplifier performs low-noise amplification for downlink RF signals received from the front end and performs power amplification for uplink RF signals to be sent to the front end. The transceiver converts analog signals into uplink RF signals to be sent to the amplifier and converts downlink RF signals received from the amplifier into analog signals. The LTE modem demodulates analog signals received from the transceiver into original digital signals according to the LTE protocol and modulates digital signals into analog signals to be sent to the transceiver. Particularly, the LTE RF unit 130 performs a function to control Inter-RAT handover. For this, the LTE RF unit 130 directly communicates with the WiMAX RF unit 140 through, for example, a Universal Asynchronous Receiver/Transmitter (UART), a Serial Peripheral Interface (SPI), or a General Purpose Input Output (GPIO) pin or interface.

The WiMAX RF unit 140 accesses the WiMAX communication network and then performs a location registration and a data communication. Also, the WiMAX RF unit 140 transmits and receives signals related to a voice call, a video call, a SMS, a MMS, and a data communication to and from the target electronic device 10 through the switching unit 120 and the interface unit 110. And also, the WiMAX RF unit 140 includes a front end, an amplifier, a transceiver, a WiMAX modem, a memory, a power manager, and a Subscriber Identification Module (SIM).

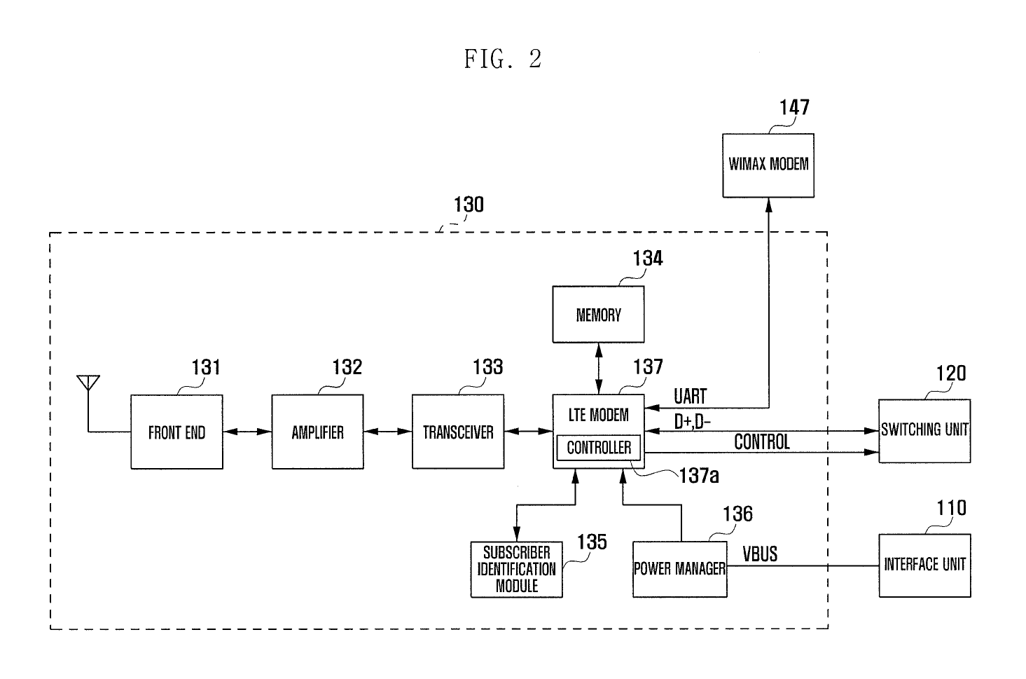

FIG. 2 is a block diagram illustrating the configuration of an LTE RF unit according to an exemplary embodiment of the present invention.

Referring to FIG. 2, the LTE RF unit 130 includes a front end 131, an amplifier 132, a transceiver 133, a memory 134, a SIM 135, a power manager 136, and an LTE modem 137.

As discussed, above, the front end 131 performs a band-pass filtering for downlink RF signals received from the antenna and then outputs the band-pass filtered downlink RF signals having LTE frequency band to the amplifier 132, and also performs a band-pass filtering for uplink RF signals received from the amplifier 132 and then sends the band-pass filtered uplink RF signals to the antenna. The amplifier 132 performs low-noise amplification for downlink RF signals received from the front end 131 and then sends the amplified downlink RF signals to the transceiver 133, and also performs power amplification for uplink RF signals received from the transceiver 133 and then outputs the amplified uplink RF signals to the front end 131. The transceiver 133 converts analog signals received from the LTE modem 137 into uplink RF signals and then outputs the uplink RF signals to the amplifier 132, and also converts downlink RF signals received from the amplifier 132 into analog signals and then outputs the analog signals to the LTE modem 137.

The memory 134 stores an operating system, a LTE protocol, RF control information, and data which are for the operation of the LTE modem 137. The memory 134 may be composed of a main storage unit (not shown) and a secondary storage unit (not shown). The secondary storage unit may be formed of flash memory or Read Only Memory (ROM), and the main storage unit may be formed of Random Access Memory (RAM). The main storage unit is a memory into which the operating system and LTE protocol are loaded. Namely, when the LTE modem 137 is booted, the operating system and LTE protocol are loaded from the ROM to the RAM and are then executed. The secondary storage unit stores the operating system, the LTE protocol, and various data. The SIM 135 stores subscriber-related information required for access to the LTE network, such as identification information, a phonebook, roaming information, e-commerce information, billing information, or other similar information. The SIM 135 may also store subscriber-related information required for access to other communication networks, such as the WiMAX network. The power manager 136 manages the power of the LTE modem 137.

The LTE modem 137 demodulates analog signals received from the transceiver 133 into original digital signals according to the LTE protocol and then sends the original data signals to the switching unit 120, and also modulates digital signals received from the switching unit 120 into analog signals and then sends the analog signals to the transceiver 133. Additionally, the LTE modem 137 is able to camp on the LTE communication network and perform a location registration in the LTE communication network by using subscriber information in order to perform data communication.

More particularly, the LTE modem 137 controls a selection of communication paths. For this, the LTE modem 137 directly communicates with a WiMAX modem 147 through, for example, UART, SPI, or GPIO modules or interfaces. Furthermore, the LTE modem 137 has a controller 137a that controls modems of other RF units and the switching unit 120. Under the control of the controller 137a, the switching unit 120 connects one of the LTE RF unit 130 and the WiMAX RF unit 140 to the interface unit 110. Specifically, when the MBMM wireless communication apparatus 100 is connected to the target electronic device 10, the LTE modem 137 is booted. Then the controller 137a of the LTE modem 137 selects a RF unit to be connected to the target electronic device 10, according to a scenario stored in the memory 134. This scenario may be an automatic scenario that instructs the controller 137a to select a particular RF unit that is in better condition for receiving radio signals from among the LTE RF unit 130 and the WiMAX RF unit 140, or a manual scenario that instructs the controller 137a to select a particular RF unit according to an order predetermined by a user. For instance, the manual scenario may instruct the controller to first select the LTE RF unit 130, which is a master modem performing a control function.

In a case of the automatic scenario, the controller 137a of the LTE modem 137 attempts to camp on the LTE communication network. Also, the controller 137a of the LTE modem 137 attempts to camp on the WiMAX communication network by booting the WiMAX modem 147. The controller 137a of the LTE modem 137 selects, as a communication path for the target electronic device 10, a particular RF unit succeeding in the camping and then controls the switching unit 120 to connect the selected RF unit to the target electronic device 10. If the camping is successful in two communication networks using the two RF units, the controller 137a of the LTE modem 137 calculates a signal receiving condition of the LTE RF unit 130 using an indicator, such as a Received Signal Strength Indication (RSSI), a Signal to Noise Ratio (SNR), or an Energy per chip over the Interface noise (Ec/Io) indicator.

Additionally, the controller 137a of the LTE modem 137 controls the WiMAX modem 147 to calculate information regarding the signal receiving condition of the WiMAX RF unit 140 and then receives the calculated information from the WiMAX RF unit 140. Next, the controller 137a of the LTE modem 137 compares the two conditions of the LTE RF unit 130 and the WiMAX RF unit 140 and selects a particular RF unit having a better condition as the communication path for the target electronic device 10. Next, the controller 137a of the LTE modem 137 controls the switching unit 120 to connect the selected RF unit to the target electronic device 10.

Thereafter, the controller 137a of the LTE modem 137 determines whether to continue camping and determines whether to execute an Inter-RAT handover according to the signal receiving condition, and furthermore, controls the switching unit 120 according to the determination results. Meanwhile, each communication network may offer a signal receiving condition to the MBMM wireless communication apparatus 100. Then the controller 137a of the LTE modem 137 may control the switching unit 120 according to the signal receiving condition received from each communication network. Alternatively, the Inter-RAT handover may be determined by a common base station that wholly supports various access types, such as LTE and WiMAX. In this case, the LTE modem 173 controls the switching unit 120 according to network determination information received from the common base station.

In the case of the manual scenario, the LTE modem 137 camps on the LTE network according to a predetermined order. For instance, the controller 137a of the LTE modem 137 first camps on the LTE network and, if the camping is successful, controls the switching unit 120 to connect the LTE modem 137 to the target electronic device 10. However, if the camping ends in failure, the controller 137a of the LTE modem 137 controls the WiMAX modem 147 to attempt to camp on the WiMAX network. Thereafter, the controller 137a of the LTE modem 137 determines whether to continue the camping or whether to execute an Inter-RAT handover according to the signal receiving condition and also controls the switching unit 120 according to the determination results.

Based on such a scenario, the MBMM wireless communication apparatus 100 can automatically select a communication path and perform a wireless communication without using the control of the target electronic device 10. A control function may be realized in a modem other than the LTE modem, such as the WiMAX modem 147. Additionally, a SIM, such as the SIM 135, may be contained in both the LTE RF unit 130 and the WiMAX RF unit 140. Alternatively, the SIM may be contained in only one of both RF units. In this case, subscriber information is shared between multiple RF units through UART or SPI. Meanwhile, the booting order of the modems may be determined so that a modem having a handover control function is booted first and then the other modems are booted depending on the above-discussed scenario.

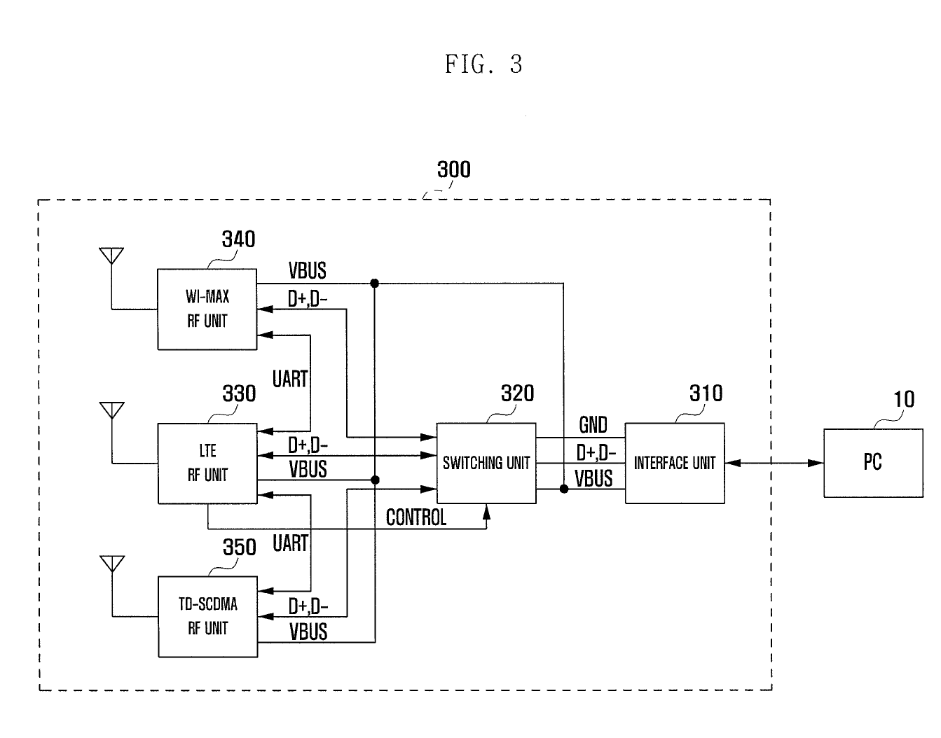

FIG. 3 is a block diagram illustrating the configuration of an MBMM wireless communication apparatus according to another exemplary embodiment of the present invention.

Referring to FIG. 3, the MBMM wireless communication apparatus 300, according to the present exemplary embodiment, includes an interface unit 310, a switching unit 320, a LTE RF unit 330, a WiMAX RF unit 340, and a Time Division Synchronous Code Division Multiple Access (TD-SCDMA) RF unit 350. Namely, the MBMM wireless communication apparatus 300 shown in FIG. 3 further includes the TD-SCDMA RF unit 350 in contrast with the above-discussed MBMM wireless communication apparatus 100, as seen in FIG. 1.

Although not shown, the TD-SCDMA RF unit 350 may have a front end, an amplifier, a transceiver, a memory, a SIM, a power manager, and a TD-SCDMA modem. Except for a difference in access types, the above noted elements in the TD-SCDMA RF unit 350 perform the same function as those in the above-discussed LTE RF unit 130 of FIG. 2. Therefore, related descriptions will be omitted for the purpose of brevity.

Although FIG. 3 shows that the LTE RF unit 330 has control functions for selecting a communication path and for performing an Inter-RAT handover, the present invention is not limited thereto. Alternatively, such control functions may be realized in the WiMAX RF unit 340 or the TD-SCDMA RF unit 350. Meanwhile, the MBMM wireless communication apparatus 300 in the present exemplary embodiment may select a communication path of the target electronic device 10 and perform the Inter-RAT handover according to the above-discussed automatic scenario or manual scenario.

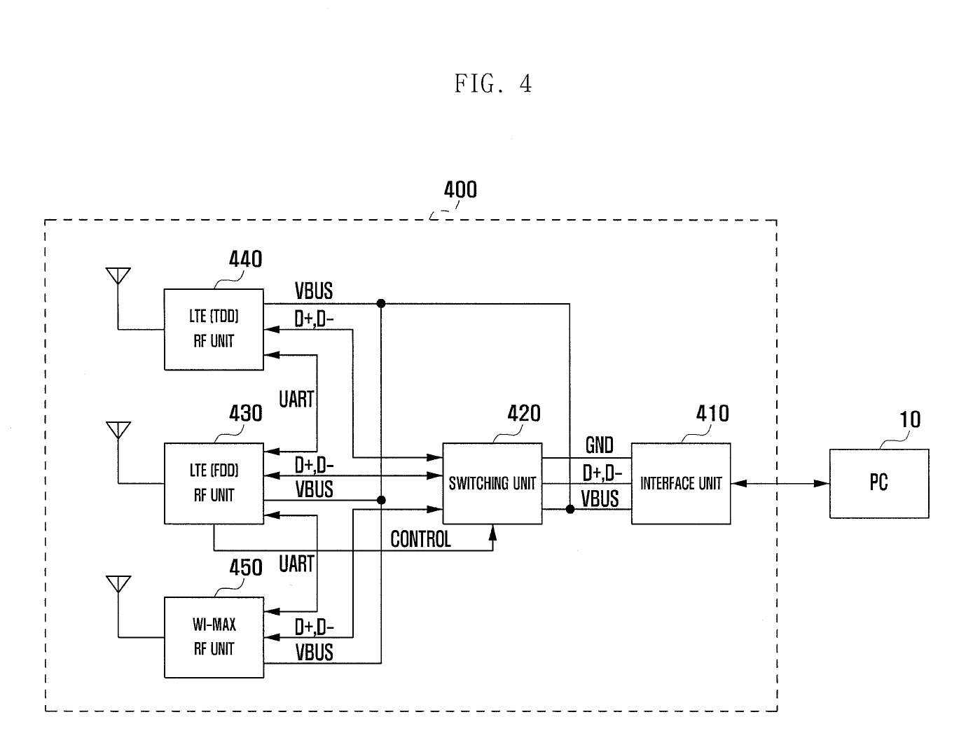

FIG. 4 is a block diagram illustrating the configuration of an MBMM wireless communication apparatus according to still another exemplary embodiment of the present invention.

Referring to FIG. 4, the MBMM wireless communication apparatus 400, according to the present exemplary embodiment, includes an interface unit 410, a switching unit 420, a Frequency Division Duplex (FDD) type LTE RF unit 430, a Time Division Duplex (TDD) type LTE RF unit 440, and a WiMAX RF unit 450. Although FIG. 4 shows that the FDD type LTE RF unit 430 has control functions, the present invention is not limited thereto, and the TDD type LTE RF unit 440 or the WiMAX RF unit 450 may alternatively have such control functions. Meanwhile, the MBMM wireless communication apparatus 400, in the present exemplary embodiment, selects a communication path of the target electronic device 10 and performs an Inter-RAT handover according to the above-discussed automatic scenario or manual scenario.

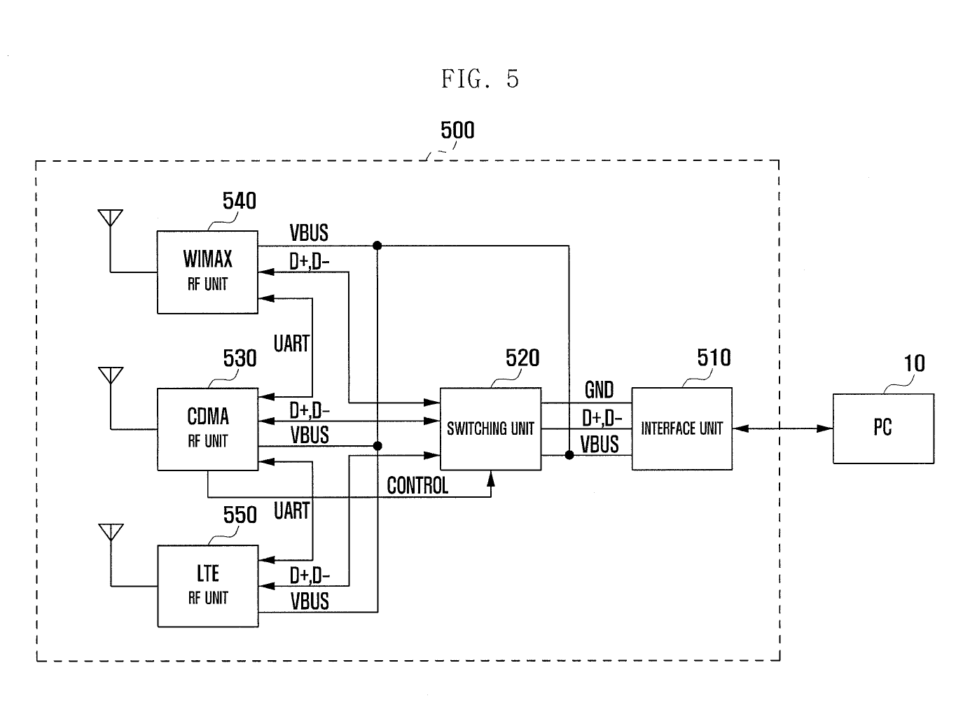

FIG. 5 is a block diagram illustrating the configuration of an MBMM wireless communication apparatus according to yet another exemplary embodiment of the present invention.

Referring to FIG. 5, the MBMM wireless communication apparatus 500, according to the present exemplary embodiment, includes an interface unit 510, a switching unit 520, a CDMA RF unit 530, a WiMAX RF unit 540, and an LTE RF unit 550. Although not shown, the CDMA RF unit 530 may have a front end, an amplifier, a transceiver, a memory, a SIM, a power manager, and a CDMA modem. Except for a difference in access type, the above noted elements of the CDMA RF unit 530 perform the same function as those in the above-discussed LTE RF unit 130 of FIG. 2. Therefore, related descriptions will be omitted for the purpose of brevity.

Although FIG. 5 shows that the CDMA RF unit 530 has control functions, the WiMAX RF unit 540 or the LTE RF unit 550 may alternatively have such control functions. Additionally, the MBMM wireless communication apparatus 500 in the present exemplary embodiment may select a communication path of the target electronic device 10 and perform an Inter-RAT handover according to the above-discussed automatic scenario or manual scenario.

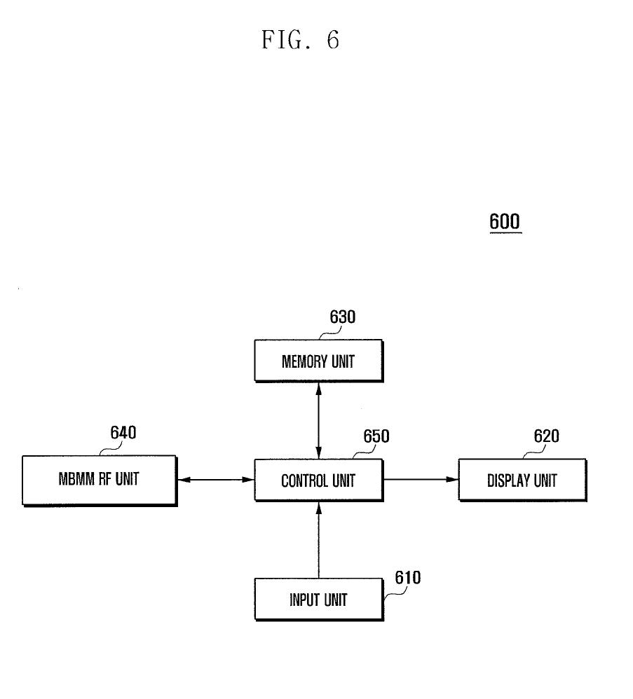

FIG. 6 is a block diagram illustrating the configuration of an electronic device according to an exemplary embodiment of the present invention.

Referring to FIG. 6, the electronic device 600, according to the present exemplary embodiment, includes an input unit 610, a display unit 620, a memory unit 630, an MBMM RF unit 640, and a control unit 650.

The input unit 610 delivers a user input event, such as a keystroke on a key input unit or a touch event on a touch screen, to the control unit 650 and the input unit 610 may include the touch screen and the key input unit or any other suitable input device. The touch screen sends the touch event to the control unit 650. This touch event may be classified into a touch-and-drop, a drag-and-drop, a flick-and-drop, and other similar touch events or gestures.

The touch-and-drop is a sequential gesture composed of pressing a certain point on the touch screen and then taking a user's finger off the point. The drag-and-drop is a sequential gesture composed of pressing a certain point on the touch screen, moving the finger to a final point without removing contact, and then taking the finger off the final point. The flick-and-drop is a sequential gesture composed of quickly moving the finger along the touch screen and then taking the finger off. The control unit 650 may distinguish between a flick gesture and a drag gesture according to a moving speed. The touch-and-drop may be divided into a tap gesture and a press gesture according to the touch duration. Namely, the tap gesture is a short touch on the touch screen, whereas the press gesture is a relatively long touch on the touch screen. Additionally, the touch event may be classified into various types according to a location, a direction, a distance, a pressure, or other similar characteristics of the touch event. The key input unit is composed of a plurality of keys used for manipulation of the electronic device 600 and delivers key events to the control unit 650.

The display unit 620 receives image data from the control unit 650, converts the received image data into analog signals, and displays the analog signals on the screen. The memory unit 630 stores a variety of programs and data required for the operation of the electronic device 600, such as an operating system, applications, and data such as images, audios, videos, or other similar data. Although not shown, the MBMM RF unit 640 may be have an interface unit, a switching unit, two or more RF units, and other similar elements and units. Since these elements are discussed above in detail with respect to FIGS. 1 through 5, discussion of the same will be avoided for the purpose of brevity. The control unit 650 controls the overall operation of the electronic device 600 and signal flows between internal elements of the electronic device 600.

While this invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A wireless communication apparatus, the apparatus comprising:
a first Radio Frequency (RF) unit for accessing a first wireless communication network, and for performing wireless communication with the first wireless communication network;
a second RF unit for accessing a second wireless communication network, the second wireless communication network being of a different access type than the first wireless communication network, and for performing wireless communication with the second wireless communication network;
an interface unit connected to a target electronic device; and
a switching unit connected to each of the first and second RF unit and for connecting at least one of the first and second RF units to the interface unit so that at least one of the first and second RF units communicates with the target electronic device,
wherein the first RF unit selects one of the first and second RF units according to information regarding a camping order of the first and second RF units or according to signal receiving conditions of the first and second RF units, and
wherein the first RF unit controls the switching unit so that the selected one of the first and second RF units is connected to the interface unit.

2. The apparatus of claim 1, wherein the first RF unit attempts to camp on the first wireless communication network, controls the second RF unit for camping on the second wireless communication network, and selects one of the first and second RF units as a communication path for the target electronic device when the selected RF unit succeeds in camping on the respective wireless communication network.

3. The apparatus of claim 2, wherein the first RF unit further comprises a controller for controlling the first RF unit's attempt to camp on the first wireless communication network, for controlling the second RF unit for camping on the second wireless communication network, and for controlling the selection of the one of the first and second RF units as a communication path for the target electronic device.

4. The apparatus of claim 2, wherein if both of the first and second RF units succeed in camping on respective wireless communication networks, the first RF unit selects the communication path of the target electronic device according to the signal receiving conditions of the first and second RF units.

5. The apparatus of claim 1, wherein the first RF unit sequentially performs the camping using the first and second RF units according to a camping order, and selects one of the first and second RF units as a communication path for the target electronic device when the selected RF unit succeeds in the camping on the respective wireless network.

6. The apparatus of claim 1, wherein the first RF unit includes a Long Term Evolution (LTE) modem, and
wherein the second RF unit includes a Wireless Interoperability for Microwave Access (WiMAX) modem.

7. The apparatus of claim 1, wherein the first RF unit includes a Wireless Interoperability for Microwave Access (WiMAX) modem, and
wherein the second RF unit includes a Long Term Evolution (LTE) modem.

8. The apparatus of claim 1, further comprising:
a third RF unit for accessing a third wireless communication network, the third wireless communication network being of a different access type than the first and second wireless communication networks, for performing wireless communication with the third wireless communication network, and for connecting to the interface unit through the switching unit under the control of the first RF unit.

9. The apparatus of claim 8, wherein the first, second and third RF units directly communicate with each other using at least one of a Universal Asynchronous Receiver/Transmitter (UART), a Serial Peripheral Interface (SPI), or a General Purpose Input Output (GPIO) pin or interface.

10. The apparatus of claim 8, wherein the third RF unit includes one of a Time Division-Synchronous Code Division Multiple Access (TD-SCDMA) modem or a Code Division Multiple Access (CDMA) modem.

11. The apparatus of claim 1, wherein the switching unit is a Universal Serial Bus (USB) hub.

12. An electronic device having a Multiband-Multimode (MBMM) Radio Frequency (RF) unit, the device comprising:
a first RF unit for accessing a first wireless communication network, and for performing wireless communication with the first wireless communication network;
a second RF unit for accessing a second wireless communication network, the second wireless communication network being of a different access type than the first wireless communication network, and for performing wireless communication with the second wireless communication network;
a control unit for controlling operations of the first RF unit and the second RF unit; and
a switching unit connected to both the first and second RF units and for connecting at least one of the first and second RF units to the control unit so that the connected at least one of the first and second RF units communicates with the control unit,
wherein the first RF unit selects one of the first and second RF units according to information regarding a camping order for the first and second RF units or according to signal receiving conditions of the first and second RF units, and
wherein the first RF unit controls the switching unit so that the selected RF unit is connected to the control unit.

13. The apparatus of claim 12, wherein the first and second RF units directly communicate with each other using at least one of a Universal Asynchronous Receiver/Transmitter (UART), a Serial Peripheral Interface (SPI), or a General Purpose Input Output (GPIO) pin or interface.

14. The apparatus of claim 13, wherein the first RF unit further comprises a first RF controller for controlling the first RF unit's selection of the one of the first and second RF units and for controlling the first RF unit's control of the switching unit.
